(19) United States
(12) Patent Application Publication
(10) Pub. No.: US 2013/0077716 A1
(43) Pub. Date: Mar. 28, 2013

(54) ANTENNA COMBINING

(71) Applicant: Josep SOLER GARRIDO, Bristol (GB)

(72) Inventor: Josep SOLER GARRIDO, Bristol (GB)

(21) Appl. No.: 13/630,601

(22) Filed: Sep. 28, 2012

(30) Foreign Application Priority Data
Sep. 28, 2011 (GB) 1116768.1

(51) Int. Cl. H04B 7/08

(52) U.S. Cl. CPC H04B 7/0851
USPC 375/316

(57) ABSTRACT

Antenna combining is carried out when the number of antennas in a receiver is greater than the number of radio frequency, RF, chains. In such a case, a weighted sum of the signals detected at the antennas is presented to the or each RF chain. In a packet based communication, weights used to create the or each weighted sum, for a particular packet, are calculated based on channel estimates determined for preceding packets.

### FIELD

Embodiments described herein relate generally to antenna combining, and to channel estimation for use in antenna combining.

### BACKGROUND

Antenna combining is a conventional technique used to increase diversity in wireless systems equipped with antenna arrays. Many combining methods can be implemented, for instance selection combining and maximal ratio combining being popular choices. Although antenna selection provides an opportunity to provide fewer RF chains than available antennas, which has power and cost advantages, it does inhibit training.

### BRIEF DESCRIPTION OF THE DRAWINGS

FIG. 1 illustrates a receiver implementing a method of antenna combining in accordance with a described embodiment;

FIG. 2 illustrates the method of antenna combining used in the receiver illustrated in FIG. 1;

FIG. 3 illustrates experimental results obtained from a simulation of the receiver illustrated in FIG. 1; and

FIG. 4 illustrates further experimental results obtained from a further simulation of the receiver illustrated in FIG. 1.

### DETAILED DESCRIPTION

Antenna selection can be used in a receiver where the number of antenna elements exceeds the number of RF chains. By only providing as many RF chains as required to serve the maximum number of active antennas, a receiver can be designed which has benefits in terms of cost, power consumption, complexity and size.

In one approach, a receiver could be conceived which has a plurality of antenna elements but only a single RF chain. The RF chain may comprise the usual mixer, filter and digital to analogue converter elements as might be familiar to the reader. In such a receiver, only one antenna element can be active at any time. An RF switch is provided, to provide connection between the active antenna element and the RF chain. The RF chain processes the signal received on the active antenna element and presents it to an ADC which then forwards the digitised signal to digital baseband processing. The digital baseband processing includes production of a control signal for controlling the RF switch, determining which of the antenna elements is to be active.

The above described arrangement can be extended, of course, to situations where more than one RF chain is available. In such a case, the RF switch would need to be designed so that it can feed the signals from a corresponding number of antenna elements to respective ones of the available RF chains.

In either of the above scenarios, fewer RF chains are available than are necessary to train the multiple antenna elements.

It would be possible to train all antenna elements for every received packet. This would imply that a packet comprises a series of training symbols, one training symbol per antenna element, followed by a series of data symbols. However, this requirement for training symbols for all antennas imposes substantial overhead on each packet. Moreover, a fast selection mechanism is required in the RF switch, to enable switching between antennas during the training process. A fast selection mechanism usually implies use of solid-state switches. Such switches have a larger insertion loss than slower MEMS based equivalents. Even using fast switches, guard intervals may be required within transmitted packets in order to perform switching.

Another approach would be to use dedicated packets to train the antennas using dedicated training packets, before data carrying packets are transmitted. The latter could then be received using the antennas identified as being the best possible for reception in the preceding training stage. This does not require in-packet switching or as many training symbols, but incurs a throughput loss due to the extra training packets sent.

Rather than limiting the number of RF chains, a receiver could be provided with as many RF chains as antenna elements. This would enable estimation of the channel at each antenna element from a single training symbol. That assumes that the transmitter sending the training symbol has a single transmission antenna. If the transmitter has multiple transmit antennas, then more training symbols will inevitably be required. The consequence of this approach would be that training data from all antenna elements at the receiver, is available simultaneously. Maximum ratio combining can be applied to the received streams. This has the potential to improve performance over the previously described examples, but a drawback of this approach is the high complexity implied by providing so many RF chains.

One embodiment provides a receiver for receiving packet based communications, the receiver comprising a plurality of antennas, and a radio frequency (RF) processing chain, a signal combiner operable to combine signals received on said antennas into a combined analogue signal to be presented to the RF processing chain, the combined analogue signal being a weighted sum, governed by weights, of said received antenna signals, a training symbol extractor operable to extract a training symbol from a received packet, a channel estimator operable to determine a channel estimate on the basis of an extracted training symbol, and a weight calculator operable to calculate said weights, said weight calculator being operable to determine weights for the receipt of a packet on the basis of channel estimates determined for previously received packets.

Another embodiment provides a method of receiving a packet based communication, for use in a receiver comprising a plurality of antennas and a radio frequency (RF) processing chain, the method comprising combining signals received on said antennas into a combined analogue signal to be presented to the RF processing chain, the combined analogue signal being a weighted sum, governed by weights, of said received antenna signals, and further comprising extracting a training symbol from a received packet, determining a channel estimate on the basis of an extracted training symbol, and calculating said weights, said calculating comprising determining weights for the receipt of a packet on the basis of channel estimates determined for previously received packets.

Another embodiment provides antenna combining to be carried out when the number of antennas in a receiver is greater than the number of radio frequency, RF, chains. In such a case, a weighted sum of the signals detected at the antennas is presented to the or each RF chain. In a packet based communication, weights used to create the or each weighted sum, for a particular packet, can be calculated based on channel estimates determined for preceding packets.

Another embodiment provides arrangements such as set out above, embodied by way of a computer implementation, configured by suitable software. In accordance with this embodiment, a computer program product comprises executable instructions which, when executed by a computer cause the computer to become configured as apparatus in accordance with one of the embodiments described herein, or to perform a method as described herein.

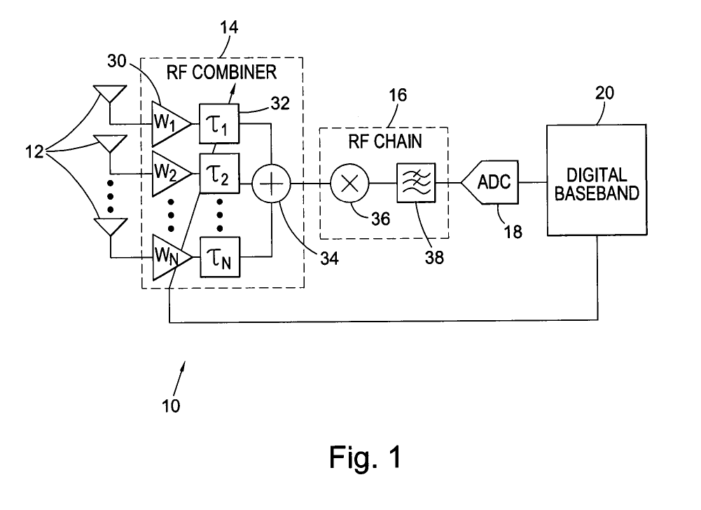

FIG. 1 illustrates a wireless communications receiver 10 which is configured in a manner which will be familiar to the person skilled in the art but, which is used in the context of the presently described embodiment, in a new manner.

The receiver 10 comprises a plurality of antenna elements 12, each of which is connected into an RF combiner 14. The RF combiner 14 acts to combine signals received on the antenna elements 12, and forwarding a combined analogue signal to a single RF chain 16. The RF chain 16 conditions the combined analogue signal, and forwards it to analogue to digital converter (ADC) 18, which converts the combined analogue signal into a digital signal stop the digital signal is then passed to a digital baseband unit 20, which processes the digital signal, extracting content, and providing control signals to the RF combiner 14.

In detail, the RF combiner 14 comprises an array of variable gain elements 30, one per antenna element 12, and phase shift devices 32, also one per antenna element 12. A combiner circuit 34 combines the gain varied and phase shifted analogue signals, to provide the combined analogue signal.

In similar detail, the RF chain 16 provides a mixer 36 and a filter 38, to take the combined analogue signal down to analogue baseband, for presentation to the ADC 18.

As used conventionally, the receiver combines signals directly in the analogue (RF) domain, hence saving hardware cost, as signals from the available antenna elements do not need to be converted to the analogue baseband and then to the digital baseband before being combined. Instead, a variable gain and phase shift is applied to each received RF signal and the combiner circuit 34 combines all of them into a single combined analogue signal, which is then converted to analogue baseband and then to the digital domain.

As will be appreciated, this example can be extended to the case of having more than one RF chain. In that case, if Nₐ antennas and N_{RF} chains are available, the RF signals from the Nₐ antennas are combined into N_{RF} RF signals. The weight applied to each received RF signal (a weight being the combination of a gain and a phase shift) is determined in baseband, and typically requires knowledge of the entire multi-antenna channel. Therefore this method has limitations similar to antenna selection systems. Both its performance and its complexity are in between those of antenna selection and digital domain combining.

In the previously described analogue (RF) antenna combining method, the weights are typically chosen so that the received (possibly averaged over time or frequency) SNR is maximized, or alternatively so that the bit error rate or block error rate of the system is minimized. This requires knowledge of the entire multi-antenna channel and hence poses the same problems as antenna selection systems, i.e. training of all the antenna elements. Typically, multiple training symbols are assumed, so that antenna switching can be performed between them and then achieve full training.

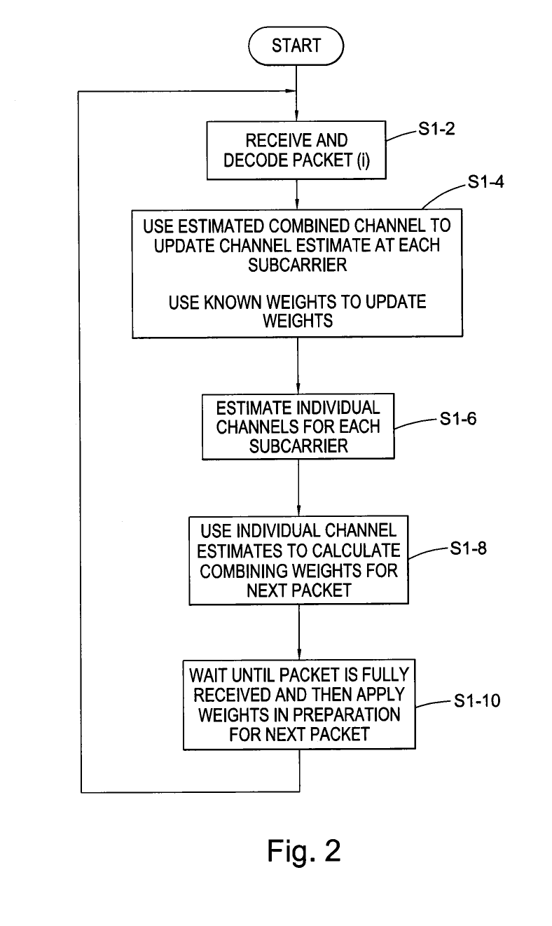

Instead, the embodiment disclosed herein is based on an approach involving processing data from a single training symbol (if a single antenna transmitter is employed) or more generally with a reduced number of symbols, and avoiding change to the antenna selected, or the weights applied, within a symbol. In a method disclosed herein, changes in the antenna configuration are restricted to the time interval within packets. FIG. 2 will now be described, to provide the reader with an understanding of this approach.

In this example, the same receiver 10 is used as previously described. However, the method for weight (gain and phase shift) calculation is intended to enable estimation of the full multi-antenna channel using a training symbols delivered one per packet, if a single transmission antenna is employed, or a reduced number of training symbols if MIMO transmission is employed, in comparison with earlier examples in the field of the embodiment.

In this example, any transmitted packet can contain data and no packet is reserved solely for use in training. This is because, when weights, to be applied for a particular packet, are calculated, this is done in a manner which involves sacrifice of performance to a very small extent, in order to allow for full channel estimation. This full channel estimation can be used for calculation of weights for the next packet, saving training overhead.

The described embodiment takes advantage of the low Doppler spread of typical indoor channels, which means channel variations in time are relatively slow. By this route, channel estimation can be conducted by making use of the current packet, and a number of previously received packets. Channel estimation takes place after each packet is received. This means that channel change can take place between packets, and the method of the presently described embodiment will accommodate that change. The only requirement is that the rate of change in the channel is sufficiently small so that the channel does not significantly change within a time window comprising Nₚ packets. Nₚ has the same order of magnitude as the ratio between the number of available antennas and the number of available RF chains. More generally, Nₚ can be greater than or equal to Nᵣ/Nₐ, with an upper bound on Nₚ defined by an implementation specific recognition that the channel does not vary significantly within the time window Nₚ:

Nₚ≧Nᵣ/Nₐ. (1)

In that case, the training symbols from the last Nₚ received packets can be used to estimate the full multi-antenna channel. Conventional channel estimation methods can be applied, for instance minimum mean square error (MMSE) channel estimation.

However, in certain scenarios, such as in the presence of very low channel variations, it is recognised that the methods described herein may provide poor channel estimates in the illustrated architecture, when weights are selected solely with the intention of improving performance. In that case, similar multi-antenna channels for the Nₚ packets will result in similar optimal weights. Each channel observation at the receiver after analogue combining consists of the superimposition of the multi-antenna channel according to the employed weights. Therefore, if channels and weights remain relatively constant, the observed combined channel will not change substantially within the Nₚ packets, and each of the Nₚ packets will essentially provide the same information about the multi-antenna channel. This would render impossible the calculation of the multi-antenna channel. In general, in order to achieve meaningful multi-antenna channel estimation, a certain degree of orthogonality is required of the combined channel observations. An assumption made in the present disclosure is that the multi-antenna channel does not change significantly within the Nₚ packets, and thus that the weights must introduce this degree of orthogonality. Accordingly, determination of the weights is not solely governed by reasons of performance.

In the described method, it is assumed that Nₚ≧Nᵣ/Nₐ consecutive packets can be transmitted within the coherence time of the channel. This is a realistic assumption for typical antenna configurations and indoor channels. Initially the case Nₐ=1 is considered for simplicity. Individual channels are denoted with the letter h whereas observed combined channels are denoted with the letter g. Sub-indices denote subcarrier numbers whereas super-indices refer to packet numbers.

The receiver of this example is configured as an OFDM system with N_{sub} subcarriers. At the receiver, a set of channel estimates gₖ^{(i-N}^{ₚ}⁺¹⁾ . . . gₖ⁽ⁱ⁾ for the most recently received Nₚ packets is available for k=1 . . . N_{sub}, along with the set of previously employed combining weights w^{(i-N}^{ₚ}⁺¹⁾ . . . w⁽ⁱ⁾.

Considering the channel at subcarrier k, the following can be written:

gₖ⁽ⁱ⁾=(W⁽ⁱ⁾)^{H}hₖ+vₖ (2)

where gₖ⁽ⁱ⁾=[gₖ^{(i-N}^{ₚ}⁺¹⁾ . . . gₖ⁽ⁱ⁾] is a Nₚ×1 vector containing the estimated (combined) channel at subcarrier k on the previous Nₚ transmissions, W⁽ⁱ⁾ is a Nₚ×Nᵣ matrix where the columns contain the previously used combining weights, i.e.:

W⁽ⁱ⁾=[w^{(i-N}^{ₚ}⁺¹⁾ . . . w⁽ⁱ⁾], (3)

and vₖ is a Nₚ×1 noise term which accounts for channel estimation errors as well as for channel variations within the Nₚ packets considered.

In a simple approximation, if channel variations due to Doppler spread are ignored and only channel estimation errors are considered, it can be assumed that the terms of vₖ are independent and identically distributed (i.i.d.) Gaussian variables with standard deviation σᵥ².

In a more sophisticated receiver, channel variations within the Nₚ packets could be taken into account, if Doppler spread information were available, assigning higher noise variances to estimations from older packets.

Considering the first case, the MMSE estimator for the channel coefficients is

$${\overline{h}}_{k}^{( i )} = {( {{W}^{( i )} ( {W}^{( i )} )}^{H} + \frac{{σ}_{v}^{2}}{{σ}_{h}^{2}} {I}_{Np \times Np} )}^{- 1} {W}^{( i )} {g}_{k}^{( i )} \qquad ( 4 )$$

where σₕ²=E{hₖhₖ*}. It can be observed that matrix inversion is only performed once per received packet, independently of the number of subcarriers. For the case where Nₐ>1, the Nᵣ antennas can be grouped in sets of Nᵣ/Nₐ elements so that the channel coefficients can be obtained with Nₐ independent estimators.

Therefore, the described combining method estimates, upon packet reception, the full channel response. This estimation can be subsequently used in order to calculate the combining weights for the next packet.

The conventional method to determine the weights in order to maximize SNR, as described for instance in U.S. Pat. No. 7,539,274 B2, would be to calculate the channel's autocorrelation matrix R and then calculate its eigenvector with the largest associated eigenvalue. That is the optimal weight vector to be applied to the antennas. In OFDM systems, the auto correlation matrix can be averaged in frequency for all the subcarriers employed.

Therefore, w⁽ⁱ⁺¹⁾ can be calculated as the largest eigenvalue of

$${R}^{( i + 1 )} = {\sum }_{k = 1}^{{N}_{sub}} ( {{\overline{h}}_{k}^{( i )} ( {h}_{k}^{( i )} )}^{H} ) \qquad ( 5 )$$

where N_{sub} is the number of subcarriers.

Therefore, a method is described for channel estimation using measurements from a single training symbol from multiple received packets and adjusting the combining coefficients only between consecutive packets. The estimation and weight-adjustment method is explained by the flowchart of FIG. 2.

As shown in the figure, the first step (S1-2) is to receive and decode the packet. A packet marked as “packet (i)” is considered here, where i is an index distinguishing that packet.

The estimated combined channel g⁽ⁱ⁾ is used (in step S1-4) to update gₖ for k=1:Nsub.

Then, in step S1-6, the individual channels hₖ are estimated for k=1:Nsub, using equation (4) set out above. The individual channels hₖ are used (step S1-8) to calculated combining weights for the next packet w⁽ⁱ⁺¹⁾. The digital baseband unit 20 then waits (step S1-10) until the packet (i) is fully received and then applies the new weights, w⁽ⁱ⁺¹⁾, in preparation for the next packet (i+1).

In order to initially estimate the channel, the first Nₚ packets can be used to switch across all the antennas, effectively creating an initial w matrix equal to the identity matrix (or many stacked identity matrices, if Nₚ≧Nᵣ/Nₐ), and an initial vector of combined channels g, where each entry corresponds to the estimated response from each individual antenna. Once this initial training phase is done, combining weights can be calculated using the described method, which effectively tracks slow variations in the channel without resorting to dedicated training packets.

The reader will appreciate that, whereas the identity matrix (or a plurality of stacked matrices) is used in the above example, any easily invertible matrix could be used instead.

However, if the channel does not change, and hence neither does the optimal combining weights between consecutive packets, the resulting W matrix is close to singular and performance of the proposed channel estimator is reduced, as aforementioned. This degradation is particularly large for low Doppler spread values. In those cases, it can be alleviated by using a larger number of packets for channel estimation Nₚ, resulting in an over-determined system spanning a larger time frame. However, a certain degree of orthogonality in the rows of W is required in order to provide an estimator with requisite performance.

A alternate approach to the computation of the weights, which provides an amelioration of this limitation, is described. The approach initially considers Nₚ=Nᵣ/Nₐ. Given a Nᵣ/Nₐ×Nᵣ/Nₐ unitary matrix A=[a₁ . . . a_{N}_{ᵣ}_{/N}_{ₐ}], an alternative sub-optimal method obtains the weight coefficients for packets (i) to (i+Nₚ−1) from the eigendecomposition of the matrices:

$$( 1 - α ) {R}^{( i )} + α tr ( {R}^{( i )} ) {a}_{1} {a}_{1}^{H} \\ ( 1 - α ) {R}^{( i + 1 )} + α tr ( {R}^{( i + 1 )} ) {a}_{2} {a}_{2}^{H}$$

$$⋮ \\ ( 1 - α ) {R}^{( i + {N}_{p} - 1 )} + α tr ( {R}^{( i + {N}_{p} - 1 )} ) {a}_{{N}_{r} / {N}_{a}} {a}_{{N}_{r} / {N}_{a}}^{H}$$

where tr() denotes the trace of a matrix, and R^{(k)} is the channel correlation matrix (averaged in frequency) as previously defined.

In the general case, the described approach merely requires that a term proportional to aᵢaᵢ^{H} is added to R. The scaling by α and the trace is provided to render the trace of the resultant matrix the same as the original, but the actual equations above can be understood just as an example of a more general idea.

A scalar α∈[0 . . . 1} determines the trade off between optimality of the weights in terms of performance and orthogonality of the wmatrix. This parameter can be determined empirically, and should be set to the lowest possible value that ensures correct channel estimation. Accordingly, the performance deterioration implicit in use of this approach can be kept to a minimum.

The weights used in each packet are therefore biased towards a certain vector aₖ, which changes each packet, sweeping constantly across the possible values. For the previous sequence, weight estimation for packet (i+Nₚ) would be biased towards a₁ again. Therefore, at each time instant, the preceding received packets, which are considered for current channel estimation, have been received with sets of combining weights calculated in a way that each of them is deviated from the optimal solution towards a given vector aᵢ from a set of orthogonal vectors A, mitigating noise enhancement problems in channel estimation.

If α is set to a zero value, the resultant combiner is the same as the first example given above, whereas α=1 produces a set of combining weights equal to the chosen row of A. Thus, if α=1, the weights depend entirely on A and not the channel, and hence no combining gain is obtained. Therefore, it is desired to choose the lowest possible value of α that ensures channel estimation is performed without noise enhancement problems, hence keeping as much of the combining gain as possible.

Simulations have been performed to show that small values of α result in much improved channel estimation with a small degradation of performance compared with optimal weight selection for systems with full training. Finally, extension for a larger number of packets Nₚ is straightforward and can be achieved by sweeping through the Nᵣ/Nₐ orthogonal vectors of A as many times as necessary.

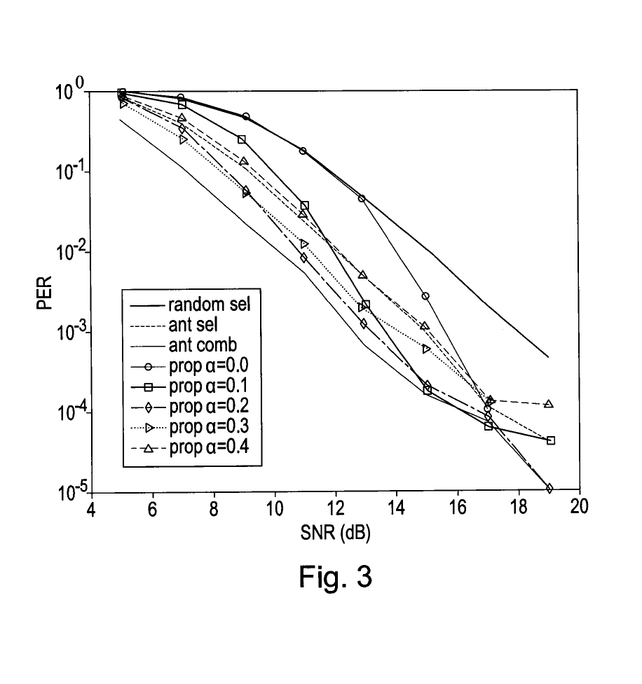

An evaluation of the method has been carried out via link level simulation of a Wireless LAN system with a receiver selecting Na=2 out of Nr=8 antennas and a single antenna transmitter is presented. Packets comprising 25 data OFDM symbols with Nsub=64 are spaced 1 ms in time. A time varying channel model was used, with a Doppler spread value corresponding to a receiver velocity of 1 ms⁻¹ for a 2.4 GHz carrier. The performance of different detectors are compared in FIG. 3, including a detector using random antenna selection, a detector using antenna selection with full training, an analogue antenna combining system with full training, and the approach taken in the method described above (and illustrated in FIG. 2) with a training scheme as described in FIG. 1 and using several values of α. It will be observed that packet error rates for α=0 (equivalent to conventional methods) are much higher than for the full training analogue combining case due to poor channel estimation. However, when α=0.2 or α=0.3, error rates approach the performance of full training thanks to the improved channel estimation.

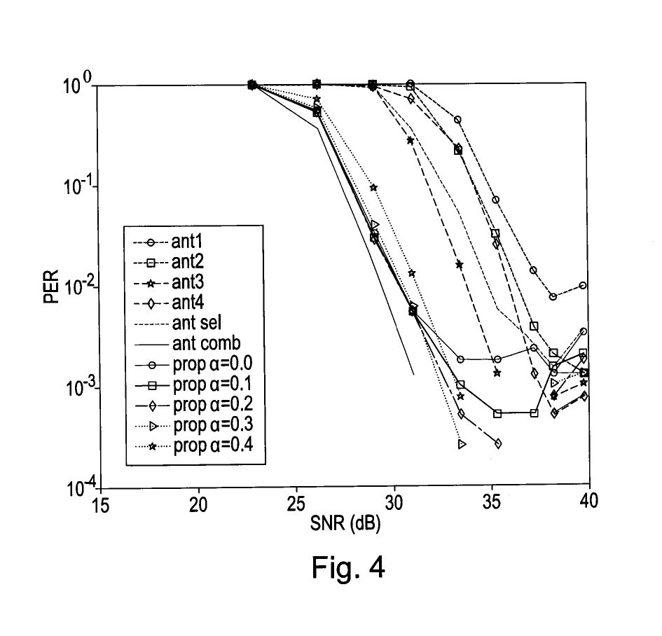

The method can also be verified experimentally using a wireless prototype. In this case the receiver selects 1 out of 4 antennas, and the operating frequency is 5.4 GHz. As demonstrated by the results illustrated in FIG. 4, average packet separation is 20 ms in a fairly static channel condition.

While certain embodiments have been described, these embodiments have been presented by way of example only, and are not intended to limit the scope of the inventions. Indeed, the novel methods and apparatus described herein may be embodied in a variety of other forms; furthermore, various omissions, substitutions and changes in the form of the methods and apparatus described herein may be made without departing from the spirit of the inventions. The accompanying claims and their equivalents are intended to cover such forms or modifications as would fall within the scope and spirit of the inventions.

1. A receiver for receiving packet based communications, the receiver comprising a plurality of antennas, and a radio frequency (RF) processing chain, a signal combiner operable to combine signals received on said antennas into a combined analogue signal to be presented to the RF processing chain, the combined analogue signal being a weighted sum, governed by weights, of said received antenna signals, a training symbol extractor operable to extract a training symbol from a received packet, a channel estimator operable to determine a channel estimate on the basis of an extracted training symbol, and a weight calculator operable to calculate said weights, said weight calculator being operable to determine weights for the receipt of a packet on the basis of channel estimates determined for previously received packets.

2. A receiver in accordance with claim 1 wherein a plurality of RF processing chains are provided, and wherein the signal combiner is operable to combine signals received on said antennas into a corresponding plurality of combined analogue signals, the weight calculator being operable to calculate weights defining each combination of signals.

3. A receiver in accordance with claim 1, wherein said weight calculator is operable to calculate said weights on the basis of channel estimates determined on receipt of a number of packets greater than or equal to a ratio of the number of antennas to the number of RF processing chains.

4. A receiver in accordance with any claim 1, wherein said training symbol extractor is operable to extract exactly one training symbol from each received packet.

5. A receiver in accordance with claim 1, and comprising a data detector operable to detect one or more data symbols in a received packet.

6. A receiver in accordance with claim 1, wherein the weight calculator is operable, for each calculated weight, to calculate a weight comprising a gain coefficient and a phase coefficient.

7. A method of receiving a packet based communication, for use in a receiver comprising a plurality of antennas and a radio frequency (RF) processing chain, the method comprising combining signals received on said antennas into a combined analogue signal to be presented to the RF processing chain, the combined analogue signal being a weighted sum, governed by weights, of said received antenna signals, and further comprising extracting a training symbol from a received packet, determining a channel estimate on the basis of an extracted training symbol, and calculating said weights, said calculating comprising determining weights for the receipt of a packet on the basis of channel estimates determined for previously received packets.

8. A method in accordance with claim 7 for a receiver in which a plurality of RF processing chains are provided, and wherein the signal combining comprises combining signals received on said antennas into a corresponding plurality of combined analogue signals, the weight calculating comprising calculating weights defining each combination of signals.

9. A method in accordance with claim 7, wherein said weight calculating comprises calculating said weights on the basis of channel estimates determined on receipt of a number of packets greater than or equal to a ratio of the number of antennas to the number of RF processing chains.

10. A method in accordance with claim 7, wherein said training symbol extracting comprises extracting exactly one training symbol from each received packet.

11. A method in accordance with claim 7, and comprising detecting one or more data symbols in a received packet.

12. A receiver in accordance with claim 7 and wherein the weight calculating comprises, for each calculated weight, calculating a weight comprising a gain coefficient and a phase coefficient.

13. A computer program product comprising computer executable instructions which, when executed by a computer, cause the computer to perform a method in accordance with claim 7.

14. A computer program product in accordance with claim 13 and comprising a computer readable storage medium.

15. A computer program product in accordance with claim 13 and comprising a computer receivable signal.
